(19) United States
(12) Patent Application Publication
(10) Pub. No.: US 2005/0146216 A1
(43) Pub. Date: Jul. 7, 2005

(54) Anti-theft device including a remote controller with an indicator for indicating an activation time period of a command transmit key

(76) Inventor: Chi-Ting Chen, Chung-Ho City (TW)

Correspondence Address: FROMMER LAWRENCE & HAUG, 745 FIFTH AVENUE- 10TH FL., NEW YORK, NY, 10151, US

(21) Appl. No.: 10/736,066

(22) Filed: Dec. 15, 2003

(51) Int. Cl. B60R 25/00

(52) U.S. Cl. 307/10.2

(57) ABSTRACT

An anti-theft device for an automobile includes a base module and a remote controller. The remote controller is operable so as to transmit control signals that are to be received by the base module for controlling operation of the base module, and includes a command transmit key, a processor unit, a transmitter unit, and an indicator unit. The processor unit is coupled to the command transmit key. The transmitter unit is coupled to and controlled by the processor unit so as to transmit the control signals wirelessly. The processor unit controls the transmitter unit so as to transmit the control signals according to mode of activation of the command transmit key. The indicator unit is connected electrically to and controlled by the processor unit to provide an indication immediately after activation of the command transmit key for a predetermined activation time period.

### BACKGROUND OF THE INVENTION

1. Field of the Invention

The invention relates to an anti-theft device, more particularly to an anti-theft device that includes a remote controller with an indicator for indicating an activation time period of a command transmit key.

2. Description of the Related Art

A conventional anti-theft device for an automobile includes a base module and a remote controller. The remote controller includes a casing, a plurality of command transmit keys, a processor unit, and a transmitter unit. The command transmit keys are mounted on the casing, whereas the processor unit and the transmitter unit are disposed in the casing. The processor unit is coupled to the command transmit keys and the transmitter unit. The command transmit keys, upon activation, enable the processor unit to control the transmitter unit for transmitting control signals, each of which corresponds to a specific control function, such as locking and unlocking of automobile doors. The control signals are to be received by the base module and are to be respectively translated by the latter into control commands, each of which corresponds to one of the control functions.

Although the conventional anti-theft device achieves its intended purpose, each of the command transmit keys is exclusively assigned with a respective one of the control functions. As such, as the number of the control commands increases, the required number of the command transmit keys also increases, thereby resulting in a larger size for the remote controller and in higher manufacturing costs.

It is possible to assign more than one control function to a single command transmit key so as to reduce the required number of the command transmit keys. Control function selection is then made possible according to activation time period of the command transmit key. However, the proposed scheme is rarely implemented in view of inconvenience on the part of the user. That is, the user has to mentally estimate the activation time period of the command transmit key, which is, of course, prone to error.

### SUMMARY OF THE INVENTION

Therefore, the main object of the present invention is to provide an anti-theft device that includes a remote controller with an indicator for indicating an activation time period of a command transmit key.

Another object of the invention is to provide a remote controller with an indicator for indicating an activation time period of a command transmit key.

According to one aspect of the present invention, an anti-theft device comprises a base module and a remote controller. The remote controller is operable so as to transmit control signals that are to be received by the base module for controlling operation of the base module, and includes a casing, a command transmit key, a controller circuit, and an indicator unit. The command transmit key is mounted on the casing. The controller circuit is disposed in the casing, and includes a processor unit coupled to the command transmit key, and a transmitter unit coupled to and controlled by the processor unit so as to transmit the control signals wirelessly. The processor unit controls the transmitter unit so as to transmit the control signals according to mode of activation of the command transmit key. The indicator unit is connected electrically to and controlled by the processor unit to provide an indication immediately after activation of the command transmit key for a predetermined activation time period.

According to another aspect of the present invention, a remote controller includes a casing, a command transmit key, a controller circuit, and an indicator. The remote controller is operable so as to transmit control signals that are to be received by a base module of an anti-theft device for an automobile so as to control operation of the base module. The command transmit key is mounted on the casing. The controller circuit is disposed in the casing, and includes a processor unit coupled to the command transmit key, and a transmitter unit coupled to and controlled by the processor unit so as to transmit the control signals wirelessly. The processor controls the transmitter unit so as to transmit the control signals according to mode of activation of the command transmit key. The indicator unit is connected electrically to and controlled by the processor unit to provide an indication immediately after activation of the command transmit key for a predetermined activation time period.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram of the preferred embodiment of an anti-theft device according to the present invention;

FIG. 2 is a perspective view of a remote controller of the preferred embodiment;

FIG. 3 illustrates a first signal, and a second signal that has a duration longer than the first signal; and

FIG. 4 illustrates a single first pulse, consecutive ones of a second pulse and the first pulse, and a consecutive pair of the second pulses.

### DETAILED DESCRIPTION OF THE PREFERRED EMBODIMENT

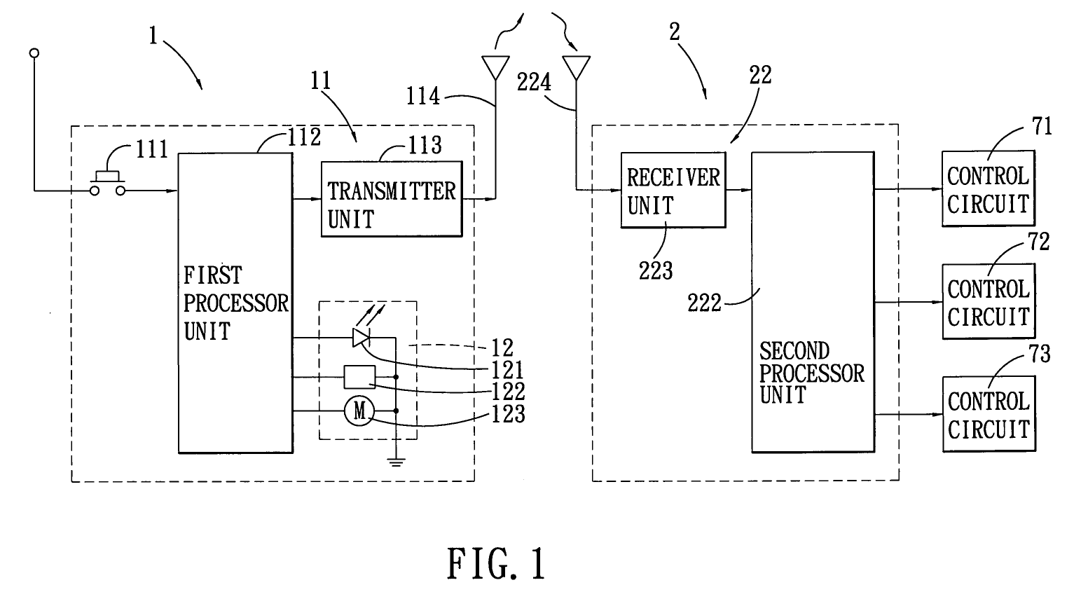

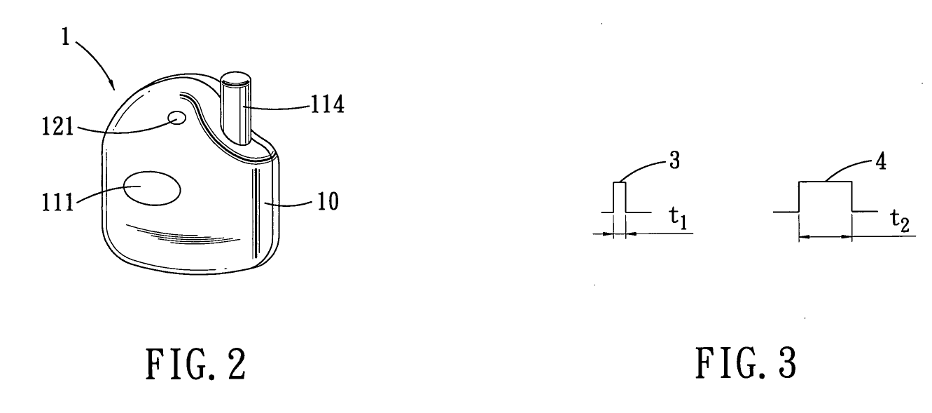

Referring to FIGS. 1 to 4, the preferred embodiment of an anti-theft device according to this invention is shown to include a base module 2 and a remote controller 1.

The anti-theft device is applied to an automobile (not shown). That is, the base module 2 is mounted on the automobile, is adapted to be coupled to control circuits 71, 72, 73, and is operable so as to activate the control circuits 71, 72, 73 for initiating various control functions, such as locking and unlocking of automobile doors, starting of an automobile engine, opening of an automobile trunk, etc. In this embodiment, the base module 2 provides first, second and third control commands to activate three of the control functions, respectively. On the other hand, the remote controller 1 is operable so as to transmit control signals that are to be received by the base module 2 for controlling operation of the base module 2, in a manner to be described hereinafter.

The remote controller 1 includes a casing 10, a command transmit key 111, a first controller circuit 11, and an indicator unit 12.

The command transmit key 111 is mounted on and is externally accessible from the casing 10. Preferably, the command transmit key 111 is a push-button switch.

Although the remote controller 1 of this invention is exemplified using only a single command transmit key 111, it should be apparent to those skilled in the art that the number of command transmit keys 111 may be increased as required.

The first controller circuit 11 is disposed in the casing 10, and includes a first processor unit 112 and a transmitter unit 113 coupled to the first processor unit 112. The first processor unit 112 is coupled to the command transmit key 111. A first antenna 114 is coupled to the transmitter unit 113. The transmitter unit 113 is controlled by the first processor unit 112 so as to transmit the control signals 5 wirelessly.

The base module 2 comprises a second controller circuit 22 that includes a second processor unit 222 and a receiver unit 223 coupled to the second processor unit 222. A second antenna 224 is coupled to the receiver unit 223. The second processor unit 22 receives the control signals 5 transmitted wirelessly by the remote controller 1 through the receiver unit 223.

In an alternative embodiment, the receiver unit 223 of the second controller circuit 22 of the base module 2 is replaced by a transceiver unit capable of receiving the control signals 5 from, as well as, transmitting acknowledge signals to the remote controller 1. Furthermore, the transmitter unit 113 of the first controller circuit 11 of the remote controller 1 is replaced by a transceiver unit capable of transmitting the control signals 5 to, as well as, receiving the acknowledge signals from the base module 2.

In this embodiment, the first processor unit 112 controls the transmitter unit 113 so as to transmit the control signals 5 according to mode of activation of the command transmit key 111. Furthermore, a shown in FIG. 3, the first processor unit 112 receives from the command transmit key 111 a first signal 3 having a first duration (t1) when the command transmit key 111 is activated for a first activation time period, and a second signal 4 having a second duration (t2) longer than the first duration (t1) when the command transmit key 111 is activated for a second activation time period that is longer than the first activation time period.

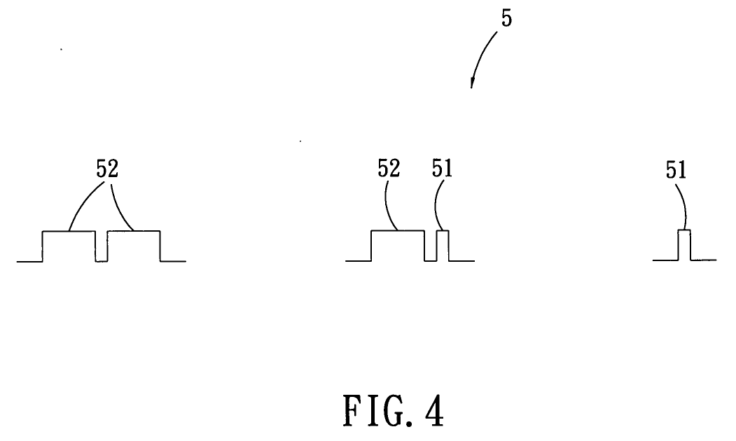

With further reference to FIG. 4, since there are three modes of activation of the command transmit key 111 in this embodiment, there are three different control signals 5 available for selection. In a first mode of activation of the command transmit key 111, the selected control signal 5 is a single first pulse 51, which in fact corresponds to the first signal 3. That is, the first pulse 51 corresponds to activation of the command transmit key 111 for the first activation time period. In this mode, the command transmit key 111 is activated for the first activation time period to enable the first processor unit 112 to generate the first pulse 51 and to activate the transmitter unit 113 for transmitting the first pulse 51. It is noted that the first pulse 51 is modulated and amplified by the transmitter unit 113 prior to transmission. The transmitted first pulse 51 is then received, demodulated and filtered by the receiver unit 223 of the base module 2, and is subsequently translated by the second processor unit 222 of the base module 2 into the first control command.

In a second mode of activation of the command transmit key 111, the selected control signal 5 includes consecutive ones of a second pulse 52 and the first pulse 51. The second pulse 52, which has a pulse duration that is longer than that of the first pulse 51, in fact corresponds to the second signal 4. That is, the consecutive ones of the second pulse 52 and the first pulse 51 correspond to activation of the command transmit key 111 for a second activation time period that is longer than the first activation time period, followed by activation of the command transmit key 111 for the first activation time period. In this mode, the command transmit key 111 is activated for the second activation time period and is thereafter reactivated for the first activation time period to enable the first processor unit 112 to generate the consecutive ones of the second pulse 52 and the first pulse 51 and to activate the transmitter unit 113 for transmitting the consecutive ones of the second pulse 52 and the first pulse 51. It is noted that the consecutive ones of the second pulse 52 and the first pulse 51 are modulated and amplified by the transmitter unit 113 prior to transmission. The transmitted consecutive ones of the second pulse 52 and the first pulse 51 are then received, demodulated and filtered by the receiver unit 223 of the base module 2, and are subsequently translated by the second processor unit 222 of the base module 2 into the second control command.

In a third mode of activation of the command transmit key 111, the selected control signal 5 includes a consecutive pair of the second pulses 52. The consecutive pair of the second pulses 52 corresponds to two successive activations of the command transmit key 111, each for the second activation time period. In this mode, the command transmit key 111 is activated for the second activation time period twice in succession to enable the first processor unit 112 to generate the consecutive pair of the second pulses 52 and to activate the transmitter unit 113 for transmitting the consecutive pair of the second pulses 52. It is noted that the consecutive pair of the second pulses 52 is modulated and amplified by the transmitter unit 113 prior to transmission. The transmitted consecutive pair of the second pulses 52 is then received, demodulated and filtered by the receiver unit 223 of the base module 2, and is subsequently translated by the second processor unit 222 of the base module 2 into the third control command.

The indicator unit 12 is connected electrically to and controlled by the first processor unit 112 to provide an indication immediately after activation of the command transmit key 111 for a predetermined activation time period. In this embodiment, the second activation time period is equal to the predetermined activation time period. As such, when the command transmit key 111 is activated for the second activation time period, as in the second and third modes of activation of the command transmit key 111, the first processor unit 112 is further enabled to generate an output signal to activate the indicator unit 12 for providing the indication.

In this embodiment, the indicator unit 12 includes a light-emitting diode 121, a vibrating motor 123 and a buzzer 122. The light-emitting diode 121 is mounted on and is externally accessible from the casing 10, and provides a visible flashing light as the indication. The vibrating motor 123 is mounted in the casing 10 and provides a sensible vibratory motion as the indication. The buzzer 122 is mounted in the casing 10 and provides an audible buzzing sound as the indication.

It has thus been shown that the anti-theft device of this invention comprises a remote controller 1 that includes a command transmit key 111, a processor unit 112, a transmitter unit 113, and an indicator 12. The command transmit key 111 enables the processor unit 112 to activate the transmitter unit 113 for transmitting control signals 5 according to activation time period of the command transmit key 111. The construction as such reduces the required number of the command transmit key 111, thereby lowering manufacturing costs. Furthermore, since the indicator 12 indicates activation of the command transmit key 111 for a predetermined activation time period, easy and accurate operation of the command transmit key 111 of the remote controller 1 can be ensured.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. An anti-theft device for an automobile, comprising:
a base module; and
a remote controller operable so as to transmit control signals that are to be received by said base module for controlling operation of said base module, said remote controller including
a casing,
a command transmit key mounted on said casing,
a controller circuit disposed in said casing, and including a processor unit coupled to said command transmit key, and a transmitter unit coupled to and controlled by said processor unit so as to transmit the control signals wirelessly, said processor unit controlling said transmitter unit so as to transmit the control signals according to mode of activation of said command transmit key, and
an indicator unit connected electrically to and controlled by said processor unit to provide an indication immediately after activation of said command transmit key for a predetermined activation time period.

2. The anti-theft device as claimed in claim 1, wherein the control signals include
a single first pulse which corresponds to activation of said command transmit key for a first activation time period and which is to be translated by said base module into a first control command,
consecutive ones of a second pulse and the first pulse which correspond to activation of said command transmit key for a second activation time period that is longer than the first activation time period, followed by activation of said command transmit key for the first activation time period, and which are to be translated by said base module into a second control command, and
a consecutive pair of the second pulses which corresponds to two successive activations of said command transmit key each for the second activation time period, and which is to be translated by said base module into a third control command,
wherein the second activation time period is equal to the predetermined activation time period, and the second pulse has a pulse duration longer than that of the first pulse.

3. The anti-theft device as claimed in claim 1, wherein said processor unit receives from said command transmit key a first signal having a first duration when said command transmit key is activated for a first activation time period, and a second signal having a second duration longer than the first duration when said command transmit key is activated for a second activation time period that is longer than the first activation time period and that is equal to the predetermined activation time period.

4. The anti-theft device as claimed in claim 1, wherein said command transmit key is a push-button switch.

5. The anti-theft device as claimed in claim 1, wherein said indicator unit includes a light-emitting diode.

6. The anti-theft device as claimed in claim 1, wherein said indicator unit includes a vibrating motor.

7. The anti-theft device as claimed in claim 1, wherein said indicator unit includes a buzzer.

8. The anti-theft device as claimed in claim 1, wherein said indicator unit includes at least one of a light-emitting diode, a vibrating motor, and a buzzer.

9. A remote controller operable so as to transmit control signals that are to be received by a base module of an anti-theft device for an automobile so as to control operation of the base module, said remote controller comprising:
a casing;
a command transmit key mounted on said casing;
a controller circuit disposed in said casing, and including a processor unit coupled to said command transmit key, and a transmitter unit coupled to and controlled by said processor unit so as to transmit the control signals wirelessly, said processor controlling said transmitter unit so as to transmit the control signals according to mode of activation of said command transmit key; and
an indicator unit connected electrically to and controlled by said processor unit to provide an indication immediately after activation of said command transmit key for a predetermined activation time period.

10. The remote controller as claimed in claim 9, wherein the control signals include
a single first pulse which corresponds to activation of said command transmit key for a first activation time period and which is to be translated by the base module into a first control command,
consecutive ones of a second pulse and the first pulse which correspond to activation of said command transmit key for a second activation time period that is longer than the first activation time period, followed by activation of said command transmit key for the first activation time period, and which are to be translated by the base module into a second control command, and
a consecutive pair of the second pulses which corresponds to two successive activations of said command transmit key each for the second activation time period, and which is to be translated by the base module into a third control command,
wherein the second activation time period is equal to the predetermined activation time period, and the second pulse has a pulse duration longer than that of the first pulse.

11. The remote controller as claimed in claim 9, wherein said processor unit receives from said command transmit key a first signal having a first duration when said command transmit key is activated for a first activation time period, and a second signal having a second duration longer than the first duration when said command transmit key is activated for a second activation time period that is longer than the first activation time period and that is equal to the predetermined activation time period.

12. The remote controller as claimed in claim 9, wherein said command transmit key is a push-button switch.

13. The remote controller as claimed in claim 9, wherein said indicator unit includes a light-emitting diode.

14. The remote controller as claimed in claim 9, wherein said indicator unit includes a vibrating motor.

15. The remoter controller as claimed in claim 9, wherein said indicator unit includes a buzzer.

16. The remote controller as claimed in claim 9, wherein said indicator unit includes at least one of a light-emitting diode, a vibrating motor, and a buzzer.
